(19) United States
(12) Patent Application Publication
(10) Pub. No.: US 2014/0101117 A1
(43) Pub. Date: Apr. 10, 2014

(54) METHODS AND SYSTEMS FOR MANAGING RECORDS IN AN ON-DEMAND SYSTEM

(71) Applicant: salesforce.com, inc., San Francisco, CA (US)

(72) Inventor: Ashik Uzzaman, Fremont, CA (US)

(73) Assignee: salesforce.com, inc., San Francisco, CA (US)

(21) Appl. No.: 14/026,937

(22) Filed: Sep. 13, 2013

Related U.S. Application Data
(60) Provisional application No. 61/711,960, filed on Oct. 10, 2012.

(51) Int. Cl. G06F 17/30

(52) U.S. Cl. CPC G06F 17/30082
USPC 707/694; 707/687; 707/698

(57) ABSTRACT

Methods and systems are provided for managing records in a database. An exemplary method involves a server coupled to the database determining a value indicative of a relative uniqueness of an input record based on a subset of a plurality of fields of the input record and storing the input record in the database when that value is unique among one or more values for one or more existing records in the database. Each value of the one or more values for the existing records is also based on the subset of the plurality of fields of a respective existing record and is indicative of the relative uniqueness of that respective existing record.

### CROSS-REFERENCE TO RELATED APPLICATION(S)

This application claims the benefit of U.S. provisional patent application Ser. No. 61/711,960, filed Oct. 10, 2012, the entire content of which is incorporated by reference herein.

### TECHNICAL FIELD

Embodiments of the subject matter described herein relate generally to computer systems, and more particularly, to methods and systems for managing potentially duplicate records in an on-demand computing system.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users. For example, a multi-tenant system may support an on-demand customer relationship management (CRM) application that manages the data for a particular organization's sales staff that is maintained by the multi-tenant system and facilitates collaboration among members of that organization's sales staff (e.g., account executives, sales representatives, and the like).

As the amount of data maintained by an on-demand system increases and/or the number of users supported by the on-demand system increases, the likelihood of duplicate data entries existing within the system also increases. Duplicate data entries not only undesirably waste computing resources, but also have the potential to confuse users or cause conflicts within the system. Accordingly, methods and systems are desired for limiting or otherwise preventing the proliferation of duplicate data entries in on-demand systems.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary on-demand application system;

FIG. 2 is a flow diagram of an exemplary duplicate definition process suitable for implementation by the on-demand application system of FIG. 1 in accordance with one or more embodiments;

FIG. 3 is a flow diagram of an exemplary duplicate detection process suitable for implementation by the on-demand application system of FIG. 1 in accordance with one or more embodiments;

FIG. 4 is a diagram illustrating a sequence of communications within the on-demand application system of FIG. 1 in accordance with one exemplary embodiment of the duplicate detection process of FIG. 3;

FIG. 5 is a diagram illustrating a sequence of communications within the on-demand application system of FIG. 1 in accordance with another exemplary embodiment of the duplicate detection process of FIG. 3;

FIG. 6 is a block diagram of an exemplary multi-tenant system suitable for use as the on-demand application system of FIG. 1 in accordance with one or more embodiments.

### DETAILED DESCRIPTION

Embodiments of the subject matter described herein generally relate to methods and systems for managing records in an on-demand system by detecting potentially duplicate records upon submission for entry to a database and preventing potentially duplicate records from being entered or otherwise stored in the database in the absence of a manual override. As described in greater detail below, a value indicative of a relative uniqueness (alternatively, a uniqueness value) of an input record is calculated or otherwise determined based on the values for a subset of the fields of the input record, while remaining fields of the input record are excluded or otherwise disregarded. In other words, not all of the fields of data of a record are utilized to calculate the uniqueness value. In exemplary embodiments, the particular subset of fields utilized for determining the uniqueness value are indicated, identified, or otherwise defined by a duplicate detection rule maintained in the database. Depending on the embodiment, each duplicate detection rule may be object-specific (e.g., a different subset of fields are used for records of different object types) and/or tenant-specific (e.g., a subset of fields used for records of one object type that are associated with a particular tenant is different from the subset of fields used for records of that object type that are associated with a different tenant).

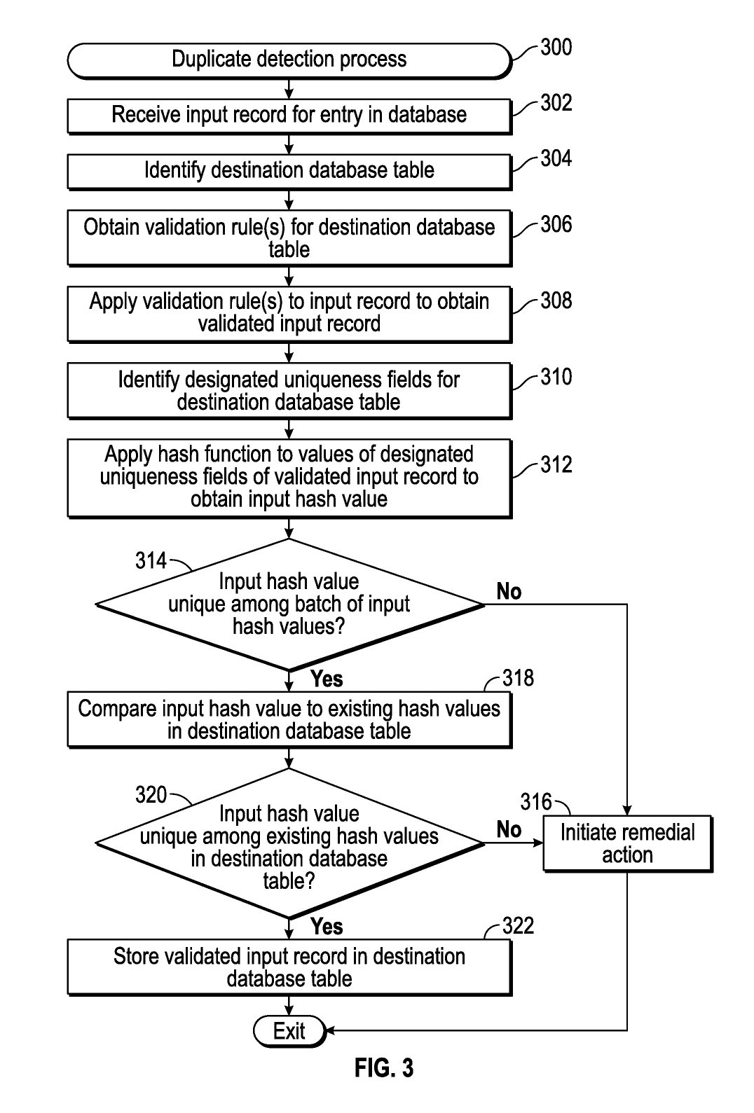

In exemplary embodiments, the uniqueness value is a hash value that is calculated or otherwise determined by providing the values for the respective fields of the subset of the input record as input parameters to a hash function. As described in greater detail below in the context of FIGS. 3-5, in exemplary embodiments, the hash value for an input record is compared to hash values calculated based on values for the subset of fields of one or more existing record(s) in the database. When the input hash value for the input record is unique relative to the existing hash values for the existing record(s), the input record is stored, saved, or otherwise entered to the database. Conversely, when the input hash value matches one or more existing hash values, in the absence of a manual override, the input record is discarded or otherwise deleted without being entered to the database. In exemplary embodiments, prior to determining the hash value for the input record, one or more validation rules are applied to the input record to ensure that values for the various fields of the input record satisfy any applicable validation rules, for example, by overwriting an invalid value for a particular field of the input record with a default value. In this regard, the hash value is determined based on the validated input record, such that only valid input values and/or default values are provided as input parameters to the hash function. In a similar manner as described above in the context of the duplicate detection rule, the validation rules may also be object-specific and/or tenant-specific.

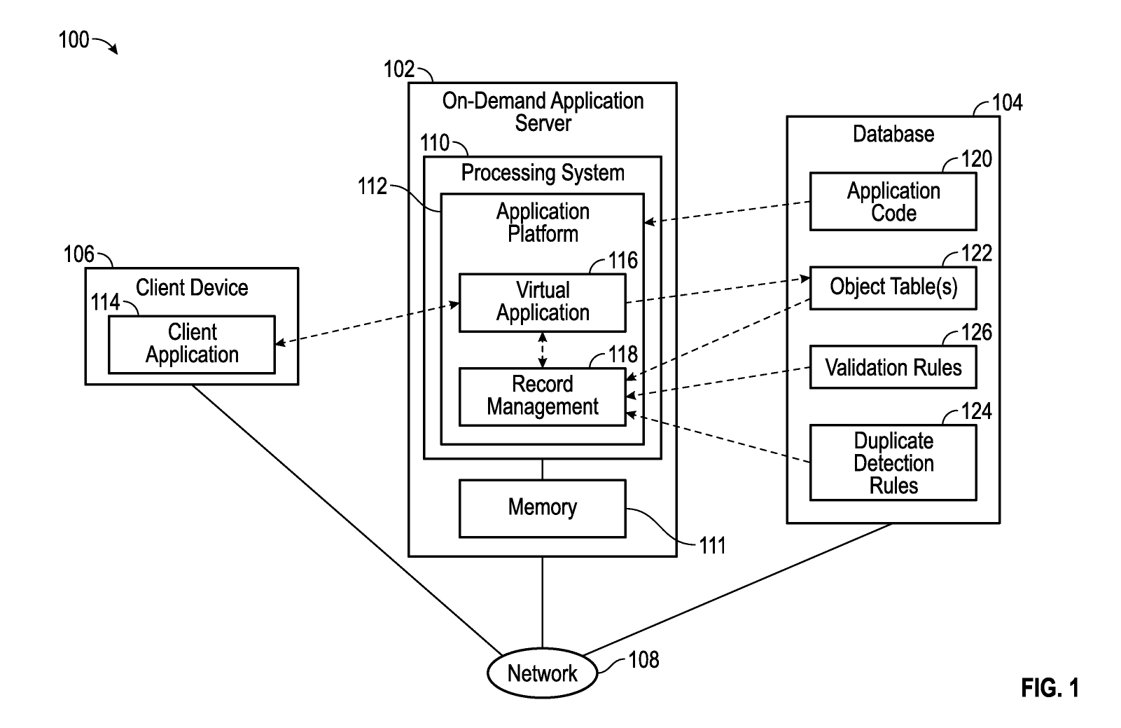

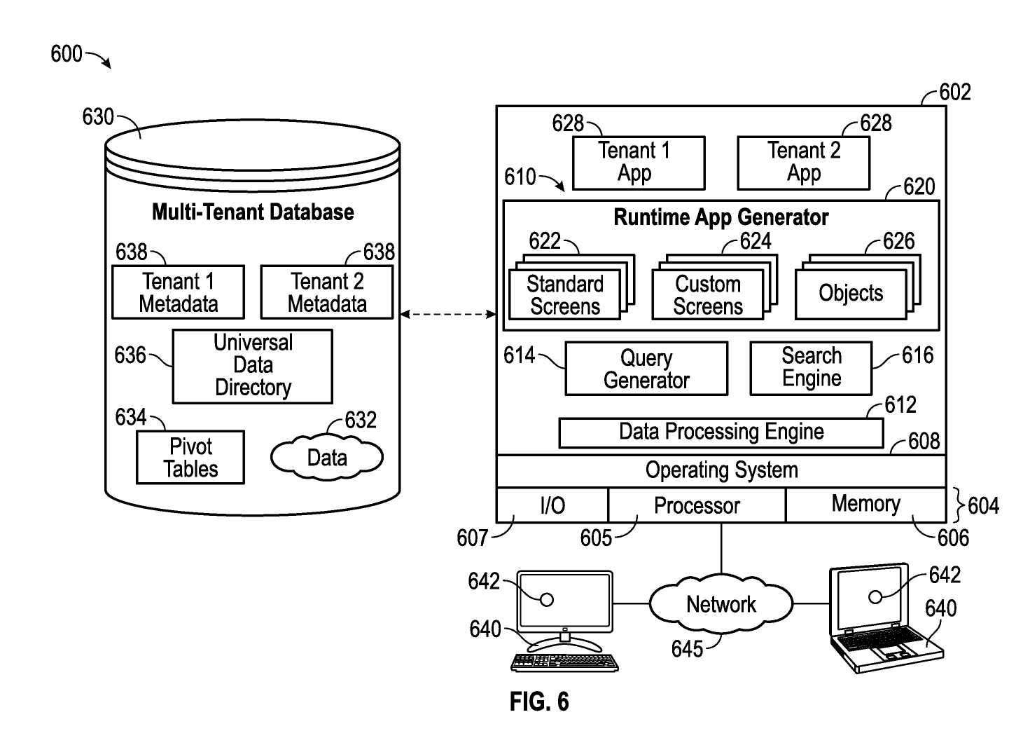

Turning now to FIG. 1, an exemplary on-demand application system 100 includes an application server 102 that includes or otherwise implements an application platform 112 capable of generating one or more instances of a virtual application 116 at run-time (or “on-demand”) based upon data stored or otherwise maintained by a database 104 that is communicatively coupled to the application server 102 via a communications network 108, such as a wired and/or wireless computer network, a cellular network, a mobile broadband network, a radio network, or the like. In this regard, the application server 102 and the database 104 cooperatively provide a cloud computing platform (or framework). In accordance with one or more embodiments, the database 104 is realized as a multi-tenant database that is shared between multiple tenants, with each tenant having its own set of associated users. In this regard, the database 104 may store or otherwise maintain data associated with a number of different tenants and restrict accessibility of one tenant's data with respect to other tenants' data, as described in greater detail below in the context of FIG. 6.

In the illustrated embodiment of FIG. 1, the application server 102 generally represents a computing system or another combination of processing logic, circuitry, hardware, and/or other components configured to support the record management processes, tasks, operations, and/or functions described herein. In this regard, the application server 102 includes a processing system 110, which may be implemented using any suitable processing system and/or devices, such as one or more processors, central processing units (CPUs), controllers, microprocessors, microcontrollers, processing cores and/or other hardware computing resources configured to support the operation of the processing system 110 described herein. The processing system 110 may include or otherwise access a data storage element 111 (or memory) capable of storing programming instructions for execution by the processing system 110, that, when read and executed, cause processing system 110 to create, generate, or otherwise facilitate the application platform 112 that generates or otherwise provides instances of the virtual application 116 at run-time (or “on-demand”) based upon data and/or code 120 that is stored or otherwise maintained by the database 104. Depending on the embodiment, the memory 111 may be realized as a random access memory (RAM), read only memory (ROM), flash memory, magnetic or optical mass storage, or any other suitable non-transitory short or long term data storage or other computer-readable media, and/or any suitable combination thereof

In exemplary embodiments, an instance of the virtual application 116 is provided to a client device 106 that is communicatively coupled to the application server 102 via a communications network, such as network 108. In this regard, the client device 106 generally represents an electronic device coupled to the network 108 that is utilized by a user to access the application platform 112 and/or virtual application 116 on the application server 102. In practice, the client device 106 can be realized as any sort of personal computer, mobile telephone, tablet or other network-enabled electronic device that includes a display device, such as a monitor, screen, or another conventional electronic display, capable of graphically presenting data and/or information provided by the application platform 112 and/or the virtual application 116 along with a user input device, such as a keyboard, a mouse, a touchscreen, or the like, capable of receiving input data and/or other information from the user of the client device 106.

A user may manipulate the client device 106 to execute a client application 114, such as a web browser application, and contact the application server 102 and/or application platform 112 using a networking protocol, such as the hypertext transport protocol (HTTP) or the like. In response, the application server 102 and/or application platform 112 accesses the database 104 to obtain or otherwise retrieve application code 120, which includes computer-executable code segments, instructions, scripts or the like that are executed by the processing system 110 and/or application platform 112 to generate the virtual application 116. The application platform 112 authenticates or otherwise identifies the user and generates the virtual application 116 at run-time based upon information and/or data maintained by the database 104 that is associated with the user and/or the user's associated tenant. The virtual application 116 may include code, data and/or other dynamic web content provided to the client device 106 that is parsed, executed or otherwise presented by the client application 114 running on the client device 106. In an exemplary embodiment, the virtual application 116 is a virtual customer relationship management (CRM) application.

The virtual application 116 typically includes one or more graphical user interface (GUI) displays generated by the application platform 112 based on data obtained from the database 104. For example, the GUI displays may pertain to the database objects associated with or otherwise belonging to a particular tenant supported by the database 104, and the GUI displays may include GUI elements or widgets that allow the user of the client device 106 to select or otherwise identify the database object(s) of interest to the user (e.g., a particular account, opportunity, contact, or the like in the case of a CRM application) along with GUI elements or widgets that allow the user to initiate or otherwise perform various activities with respect to a selected database object (e.g., create a new instance of a database object and input values for fields of the new object, modify values for fields of an existing instance of a database object, and the like).

Still referring to FIG. 1, in exemplary embodiments described herein, the database 104 includes or otherwise maintains a plurality of object tables 122 corresponding to the different types of objects available to the user of the client device 106 within the virtual application 116. In general, an object is a data structure that maintains a logical association among data values and is utilized by the virtual application 116 to generate GUI displays and provide other features and/or functionality for the virtual application 116. For example, the database 104 may maintain standard objects available to all users and/or tenants within the on-demand system 100 and custom objects that are available only to particular users and/or particular tenants within the on-demand system 100. Each object table 122 includes a plurality of columns that correspond to the respective fields of the object type associated with that respective object table 122, with each row (or record or entry) in a respective object table 122 corresponding to a respective instance of that type of object. For example, an object table 122 associated with an “account” object includes columns corresponding to the account object fields, with each row (or entry) in the account object table 122 corresponding to a different account and having values for the columns of that respective row that correspond to the respective account object fields of that respective account. Additionally, in multi-tenant implementations, each object table 122 includes a column that corresponds to the tenant identifier, with each record in a respective object table 122 including the tenant identifier for the tenant associated with that particular instance of that type of object.

As described in greater detail below, in exemplary embodiments, each object table 122 also includes a column (or field) corresponding to a hash value for a respective record in that object table 122. In this regard, the hash value is a value or metric indicative of the relative uniqueness of a particular record (or entry) in the respective object table 122 with respect to other existing records in the respective object table 122 and/or input records submitted for entry in the respective object table 122. The hash value is calculated or otherwise determined based on the values for a subset of the columns (or fields) of that respective record that have been designated as being indicative of the relative uniqueness of an individual record in that object table 122.

In the illustrated embodiment, the database 104 includes a duplicate definition table 124, where each entry in the table 124 provides a duplicate detection rule (or uniqueness validation rule) that is applied to records (or instances) of a particular object type for identifying potentially duplicate records of that object type. In this regard, a duplicate detection rule indicates, identifies, or otherwise defines the subset of the fields (or columns) of a particular database object table 122 that have been selected or otherwise designated as being indicative of the uniqueness of a record of that object type relative to other records in that object table 122. The subset of fields indicated by an entry for a duplicate detection rule in the table 124 are utilized to calculate the hash value used to detect whether a record (or instance) of a particular object type that is input or otherwise submitted to the application server 102 via the virtual application 116 for entry in the database 104 is potentially a duplicate of an existing record of that object type. For purposes of explanation, the subset of fields utilized to calculate the hash value may alternatively be referred to herein as the designated uniqueness fields. In exemplary embodiments, each entry in the table 124 is also associated with a particular tenant supported by the on-demand system 100, such that each duplicate detection rule is only applied to records or entries associated with that tenant. It should be noted that in alternative embodiments, the duplicate detection rule may indicate, identify, or otherwise define the subset of the fields (or columns) of a particular database object table 122 that have been selected or otherwise designated to be excluded from use in the hash function (e.g., fields that are not likely to be indicative of uniqueness).

In exemplary embodiments, the database 104 also includes or otherwise maintains a validation table 126 that includes one or more validation rules that may be applied to the records or entries in the various database object tables 122. A validation rule provides validation criteria for one or more fields (or columns) of a particular database object type, such as, minimum and/or maximum values for a particular field, a range of allowable values for the particular field, a set of allowable values for a particular field, or the like. Additionally, the validation rule may provide a default value to be assigned to a field (or column) of a particular database object table 122 when the value for that field of a particular record or entry in that database object table 122 do not satisfy the validation criteria for that field. In this regard, the validation rules associated with a particular database object table 122 may be applied to the individual records or entries in that table 122 to ensure that the values for all of the columns or fields of the table 122 are equal to valid (or allowable) values. In exemplary multi-tenant embodiments, a validation rule associated with a particular database object table 122 is also associated with a particular tenant supported by the on-demand system 100, such that that validation rule is only applied to records or entries associated with that tenant in that table 122. In this regard, the validation criteria and/or default criteria for the various fields of a particular database object may be specified or otherwise defined by a user associated with the tenant whose records are subjected to that validation rule.

In the illustrated embodiment of FIG. 1, the record management engine 118 generally represents a software module or another feature that is generated or otherwise implemented by the application platform 112 to facilitate the identification of potentially duplicate data that is input or otherwise provided to the application server 102 via the virtual application 116 for entry in the database 104. For example, a user of the client device 106 may manipulate GUI displays provided by the virtual application 116 within the client application 114 to input data for creating a new instance of a database object or modifying values for fields of an existing instance of a database object. As described in greater detail below in the context of FIGS. 3-5, in response to receiving an indication from the client device 106 and/or the client application 114 to store, save, or otherwise enter an instance of a database object in the database 104, the record management engine 118 calculates or otherwise determines a hash value for the input instance of the database object based on the input values for the subset of fields of the instance that correspond to the designated uniqueness fields that are indicated by the entry in the table 124 that is associated with that database object type and the tenant associated with the user of the client device 106. The record management engine 118 identifies the destination database object table 122 for the input instance and compares the hash value for the input instance to hash values for existing instances of that object type that are already stored or otherwise maintained in the destination database object table 122. The record management engine 118 automatically stores or otherwise enters the input instance of the database object to the destination table 122 when the input hash value is not equal to the existing hash values. When the input hash value matches an existing hash value, the record management engine 118 initiates one or more remedial actions instead of automatically storing the input instance of the database object to the destination database object table 122. For example, the record management engine 118 may discard or otherwise delete the input instance of the database object or provide a notification to the user of the client device 106 that the instance is potentially a duplicate of an existing instance of that database record and allow the user to override the duplicate detection and allow the input instance to be stored in the destination database object table 122. In this manner, potentially duplicate records may be prevented from entry in the database 104 upon submission, thereby conserving resources of the database 104.

In some embodiments, prior to calculating the input hash value, the record management engine 118 applies one or more validation rules associated with the destination database object table 122 to an input instance of the corresponding object type to ensure that the values for the fields of the input instance are valid for entry in the destination database object table 122. In this manner, any invalid values for fields of the input instance may be overwritten with default values to obtain a validated input record before calculating the input hash value based on the designated fields of the validated input record. Additionally, in some embodiments, when a batch of multiple instances of a database object are being submitted to the database 104, the record management engine 118 calculates hash values for all of the instances of that database object and compares those input hash values to one another to ensure there are no duplicate input hash values among the batch. In this regard, when two input hash values match, the record management engine 118 initiates one or more remedial actions prior to comparing the input hash values to the existing hash values for the destination database table 122. For example, the record management engine 118 may discard or otherwise delete one of the matching input instances of the database object or provide a notification to the user of the client device 106 that the matching instances are potentially duplicates and allow the user to select which of the matching instances should be stored in the database 104 or to otherwise override the duplicate detection and allow both matching input instances to be stored in the destination database object table 122.

It should be understood that FIG. 1 is a simplified representation of an on-demand application system provided for purposes of explanation and is not intended to limit the subject matter described herein. For example, although FIG. 1 depicts the record management engine 118 as being separate from the virtual application 116, in practice, the features and/or functionality of the record management engine 118 may integrated into or otherwise implemented by the virtual application 116. Additionally, although FIG. 1 depicts the client device 106 communicating on the same network 108 that the application server 102 and the database 104 communicate on, in practice, the client device 106 and the application server 102 may communicate via a communications network that is separate and/or distinct from the network 108. For example, the client device 106 could communicate with the application server 102 via a cellular network or the Internet, while the application server 102 communicates with the database 104 via a local area network (LAN).

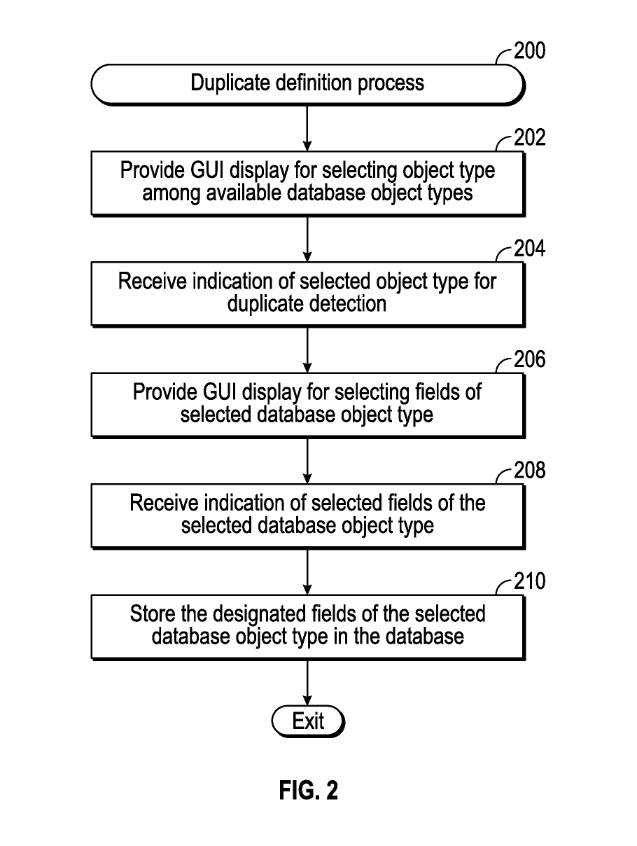

FIG. 2 depicts an exemplary embodiment of a duplicate definition process 200 suitable for implementation by an on-demand application system to allow a user to define a duplicate detection rule by designating uniqueness fields subsequently used to identify potential duplicates of a type of database object. The various tasks performed in connection with the illustrated process 200 may be performed by software, hardware, firmware, or any combination thereof. For illustrative purposes, the following description may refer to elements mentioned above in connection with FIG. 1. In practice, portions of the duplicate definition process 200 may be performed by different elements of the on-demand application system 100, such as, for example, the application server 102, the database 104, the processing system 110, the application platform 112, the virtual application 116, the record management engine 118 and/or the application code 120. It should be appreciated that the duplicate definition process 200 may include any number of additional or alternative tasks, the tasks need not be performed in the illustrated order and/or the tasks may be performed concurrently, and/or the duplicate definition process 200 may be incorporated into a more comprehensive procedure or process having additional functionality not described in detail herein. Moreover, one or more of the tasks shown and described in the context of FIG. 2 could be omitted from a practical embodiment of the duplicate definition process 200 as long as the intended overall functionality remains intact.

Referring now to FIGS. 1-2, in an exemplary embodiment, the duplicate definition process 200 is initiated by a user of a client device 106 manipulating one or more GUI elements within the virtual application 116 to select or otherwise indicate a desire to enable duplicate record detection for records in the database 104 that are associated with or otherwise belong to the user's tenant. In response to receiving an instruction or a command to enable duplicate detection, the duplicate definition process 200 continues by providing one or more GUI displays for selecting, from among the database object types available to that user's tenant, the type of database object for which the user would like to provide duplicate detection and receiving indication of the selected database object type (tasks 202, 204). In this regard, the virtual application 116 and/or the record management engine 118 accesses the database 104 to identify what types of database objects are available to the tenant associated with the user of the client device 106 and generates or otherwise provides a GUI display within the client application 114 that includes a list of that tenant's available database object types and one or more GUI elements for selecting an individual database object type from among the list. For example, the virtual application 116 and/or record management engine 118 may present a drop-down menu that includes the standard objects supported by the database 104 (e.g., “account,” “contact,” “opportunity,” and the like) that are made available to all tenants along with any custom (or tenant-specific) objects that the database 104 supports for the user's tenant, wherein the user of the client device 106 manipulates the drop-down menu within the client application 114 to select or otherwise indicate the desired database object type for duplicate detection.

In response to receiving an indication of the desired database object type, the duplicate definition process 200 continues by providing a GUI display for selecting, from among the fields (or columns) of data associated with the selected database object type, the particular fields that the user would like to utilize when determining potentially duplicate records of the selected database object type and receiving indication of the selected database object fields (tasks 206, 208). In this regard, in response to receiving indication of a selected object type for duplicate detection, the virtual application 116 and/or the record management engine 118 accesses the object table 122 in the database 104 associated with the selected object type to identify what fields (or columns) are associated with that selected object type and generates or otherwise provides a GUI display within the client application 114 that includes a listing of the fields of that selected object type and GUI elements for selecting one or more fields from among the list. For example, if the user selects the “account” object type, the virtual application 116 and/or record management engine 118 may access the account object table 122 to identify or otherwise obtain information identifying the fields (or columns) of the account object table 122 and present a listing of all of the fields of the “account” object with a GUI element corresponding to each respective field (e.g., a check box, a radio button, or the like) to enable selection of that field for use in the duplicate detection. In this regard, the fields selected by the user are those fields of the “account” object for which the user would like preserve uniqueness among different accounts or those fields that are otherwise believed to be indicative of the relative uniqueness of an individual account relative to that tenant's other accounts in the account object table 122. Accordingly, the fields that are selected or otherwise designated by the user for use in the duplicate detection may alternatively be referred to herein as the designated uniqueness fields or the selected uniqueness fields.

In response to receiving indication of the selected fields of the selected database object type, the duplicate definition process 200 continues by storing or otherwise maintaining the designated uniqueness fields for that database object type in the database (task 210). In this regard, the virtual application 116 and/or the record management engine 118 creates a duplicate detection rule entry in the table 124 that includes an indication of the tenant associated with the user of the client device 106, an indication of the particular database object type (or database object table 122) to which the duplicate detection rule (or uniqueness validation rule) applies, and an indication of the designated uniqueness fields for that database object type. For example, an entry in the table 124 may include the unique tenant identifier for the tenant associated with the user of the client device 106, an identifier for the “account” object type (or the account object table 122), and an indication of the fields (or columns) of the account object table 122 that have been selected or otherwise designated by the user of the client device 106 for use in detecting potentially duplicate account records submitted for entry in the account object table 122. In this regard, for exemplary multi-tenant embodiments, the duplicate detection rules enforced by the virtual application 116 and/or the record management engine 118 are both tenant-specific and object-specific.

Referring to FIG. 1 and with reference to FIG. 2, it should be noted that the validation rules in the validation table 126 may be created or otherwise defined by a user of a client device 106 in a similar manner as described above in the context of the duplicate definition process 200 for the duplicate detection rules in the table 124. For example, the virtual application 116 and/or the record management engine 118 may provide a GUI display that allows a user to select or otherwise identify the database object type for which a validation rule should be applied, and thereafter, provide a GUI display that includes GUI elements that allow the user to add validation criteria for the various fields of the selected database object type. Additionally, the user may provide default values (or default criteria) to be applied to various fields of the selected database object type when the values for those fields do not satisfy the applicable validation criteria. For example, a validation criterion may require that the value for a particular field be greater than or equal to zero, and a default criterion for that particular field may be utilized to set the value for that field to zero if the input value for that field is negative. Once the validation criteria and/or default criteria have been defined, an entry is created in the table 126 that includes an indication of the tenant associated with the user of the client device 106, an indication of the particular database object type to which the validation rule applies, and an indication of the validation criteria and/or default criteria and their corresponding fields of that database object type. Accordingly, for exemplary multi-tenant embodiments, the validation rules enforced by the virtual application 116 and/or the record management engine 118 are also both tenant-specific and object-specific.

FIG. 3 depicts an exemplary embodiment of a duplicate detection process 300 suitable for implementation by an on-demand application system to detect potentially duplicate records submitted for entry in a database. The various tasks performed in connection with the illustrated process 300 may be performed by software, hardware, firmware, or any combination thereof. For illustrative purposes, the following description may refer to elements mentioned above in connection with FIG. 1. In practice, portions of the duplicate detection process 300 may be performed by different elements of the on-demand application system 100, such as, for example, the application server 102, the database 104, the processing system 110, the application platform 112, the virtual application 116, the record management engine 118 and/or the application code 120. It should be appreciated that the duplicate detection process 300 may include any number of additional or alternative tasks, the tasks need not be performed in the illustrated order and/or the tasks may be performed concurrently, and/or the duplicate detection process 300 may be incorporated into a more comprehensive procedure or process having additional functionality not described in detail herein. Moreover, one or more of the tasks shown and described in the context of FIG. 3 could be omitted from a practical embodiment of the duplicate detection process 300 as long as the intended overall functionality remains intact.

Referring to FIG. 3, and with continued reference to FIGS. 1-2, the duplicate detection process 300 begins by receiving or otherwise obtaining a record submitted for entry or storage in a database (task 302). For example, the virtual application 116 may generate or otherwise provide, within the client application 114, a GUI display that includes GUI elements that allow the user of the client device 106 to create a new instance of an object in the database 104 or modify values for fields of an existing instance of an object in the database 104. As the user inputs or otherwise provides values for fields of that instance of an object, the virtual application 116 creates a corresponding record representative of that object instance in memory 111 that includes the input values provided by the user for the various fields of the object. Additionally, the input record includes fields for the tenant identifier for the tenant associated with the user of the client device 106 along with a field identifying the database object type for the input record. After the user inputs or otherwise provides input values for fields of an instance of an object, the user manipulates a GUI element presented within the client application 114 to enter, save, or otherwise submit the input record corresponding to that instance to the database 104.

The duplicate detection process 300 continues by identifying the destination database object table for the input record, obtaining validation rules for that destination database object table that are applicable to the input record, and applying the validation rules to the input record to obtain a validated input record (tasks 304, 306, 308). In this regard, the virtual application 116 and/or the record management engine 118 utilizes the identified database object type and the tenant identifier associated with the input record in memory 111 to query or otherwise access the validation table 126 to obtain validation rules associated with that database object type and the user's tenant. For example, if the input record corresponds to an “account” object and the user of the client device 106 is associated with a tenant having a tenant identifier of “orgID_{—}1,” the virtual application 116 and/or the record management engine 118 queries the validation table 126 for validation rules for “account” objects belonging to “orgID_{—}1.” After obtaining the applicable validation rules, the virtual application 116 and/or the record management engine 118 applies the validation rules to the input record to ensure values for the fields of the input record are valid or otherwise allowable for entry into the corresponding destination database object table 122. In this regard, the virtual application 116 and/or the record management engine 118 compares the input value for a particular field of the input record to any validation criteria and/or default criteria for that field that are specified by the applicable validation rules to ensure the value for that field of the input record is valid and acceptable. For example, if the input value for a field of an input account object does not satisfy the validation criteria for that field, the virtual application 116 and/or the record management engine 118 may utilize the default criteria to modify or otherwise overwrite the input value for that field of the input account object with a default value to ensure the value for that field of the input account object is valid and acceptable for entry into the account object table 122.

After validating the input record, the duplicate detection process 300 continues by identifying or otherwise determining the designated uniqueness fields for the destination database object table and applying a hash function to the values of those fields of the validated input record to obtain a hash value associated with the validated input record (tasks 310, 312). In this regard, using the tenant identifier associated with the validated input record and the identifier for the destination object table 122, the virtual application 116 and/or the record management engine 118 queries or otherwise accesses the table 124 to obtain a matching entry that includes those identifiers and corresponds to that tenant's duplicate detection rule for that database object type. After obtaining the applicable duplicate detection rule from the table 124, the virtual application 116 and/or the record management engine 118 identifies the designated uniqueness fields from that duplicate detection rule, obtains the values for those fields from the validated input record, and provides those values as input parameters to a hash function. In this manner, the virtual application 116 and/or the record management engine 118 calculates or otherwise determines a metric indicative of the relative uniqueness of the validated input record based on the input values and/or default values for the subset of fields of the validated input record that correspond to the designated uniqueness fields.

In accordance with one or more embodiments, when the input record is part of a batch of input records being entered to the database at substantially the same time, the duplicate detection process 300 compares the hash value of the input record to the hash values of other input records in the batch to detect or otherwise identify whether the hash value of a respective input record is unique among the other input records (task 314). In this regard, when the hash value of the input record matches that of another input record in a batch of records, the duplicate detection process 300 determines that the input record may be a duplicate of another input record in the batch and initiates one or more remedial actions in lieu of proceeding with submission of the input record to the database (task 316). For example, depending on the embodiment, the virtual application 116 and/or the record management engine 118 may discard the input record or otherwise remove it from the batch (e.g., by deleting the input record from memory 111) or generate a notification of a potentially duplicate record that is provided to the user of the client device 106 from which the input record was submitted. As described below, in some embodiments, the user of the client device 106 may override the duplicate detection and allow the duplicate detection process 300 to proceed with submitting the potentially duplicate input records within the batch to the database 104 in lieu of removing the potentially duplicate input records from the batch.

When the hash value for an input record is unique among other input records in the batch, the duplicate detection process 300 continues by comparing the hash value for the input record to existing hash values associated with existing records in the destination database table to detect or otherwise identify whether the input hash value is unique relative to the existing hash values in the destination database object table (tasks 318, 320). When the input hash value is unique among the existing hash values in the destination database object table, the duplicate detection process 300 continues by storing, entering, or otherwise writing the input record to the destination object table in the database (task 322). Using the tenant identifier associated with the input record and the identifier for the destination object table 122, the virtual application 116 and/or the record management engine 118 queries or otherwise accesses the destination table 122 to obtain the hash values associated with that tenant's existing records (or entries) in that destination table 122, and then compares the input hash value to those existing hash values. In exemplary embodiments, the existing hash values for the tenant's existing records are calculated or otherwise determined based on the values for the designated uniqueness fields of those records upon their submission to the database 104 and maintained in a column of the destination object table 122 corresponding to the hash value. In other words, the row (or entry) for a respective record of that tenant's existing records in the destination table 122 includes an existing hash value in the hash value column (or field) of the destination table 122, wherein that respective hash value was calculated based on the respective values for the respective designates uniqueness fields of that respective record during a previous iteration of the duplicate detection process 300 performed when that respective record was submitted to the database 104. In alternative embodiments, the existing hash values may calculated or otherwise determined by obtaining the values for the designated uniqueness fields from the entries for the existing records in the destination table 122.

When the input hash value is unique relative the existing hash values for the tenant's existing records in the destination object table 122, the virtual application 116 and/or the record management engine 118 stores or otherwise writes the input record to the destination object table 122, for example, by creating a new entry in the destination object table 122 when the input record corresponds to a new instance of a database object or overwriting an existing entry in the database object table 122 when the input record corresponds to a modification to an existing instance of a database object. The entry for the input record in the destination object table 122 includes the validated input values for fields of that database object along with any default values for any fields of the database object where the original input values provided by the user did not satisfy the validation rules applicable to that database object. In exemplary embodiments, the entry for the input record also includes the input hash value calculated based on the designated uniqueness fields of the input record and the tenant identifier associated with the user that provided the input values for the input record. In this manner, after entry in the destination object table 122, the input record becomes an existing record during subsequent iterations of the duplicate detection process 300, and the input hash value becomes an existing hash value that is stored or otherwise maintained by the destination object table 122 in association with that existing record.

When the duplicate detection process 300 determines that the input hash value for an input record matches an existing hash value in the destination database object table or is otherwise not unique among the existing hash values in the destination database object table, the duplicate detection process 300 continues by initiating one or more remedial actions (task 316). For example, in some embodiments, the virtual application 116 and/or the record management engine 118 automatically discards or otherwise removes the input record (e.g., by deleting the record from memory 111) and fails to enter the input record to the destination object table 122 when the input hash value matches an existing hash value in the destination object table 122. In other embodiments, the virtual application 116 and/or the record management engine 118 generates a notification that the input record is potentially a duplicate of an existing record in the destination object table 122 and provides the notification to the user that submitted the input record for entry in the database 104 via the virtual application 116. The notification may include a GUI element that may be manipulated by the user of the client device 106 to override the duplicate detection process 300 and enter the input record to the destination object table 122 even though the input hash value matches one or more existing hash values in the destination object table 122. In this regard, in such embodiments, an input record having a hash value that matches an existing hash value in the destination object table 122 may still be entered in the destination object table 122 only in response to receiving an override indication from the user of the client device 106 that submitted the input record. In the absence of an override indication, the virtual application 116 and/or the record management engine 118 discards or otherwise removes the input record (e.g., by deleting the record from memory 111) and fails to enter the input record to the destination object table 122.

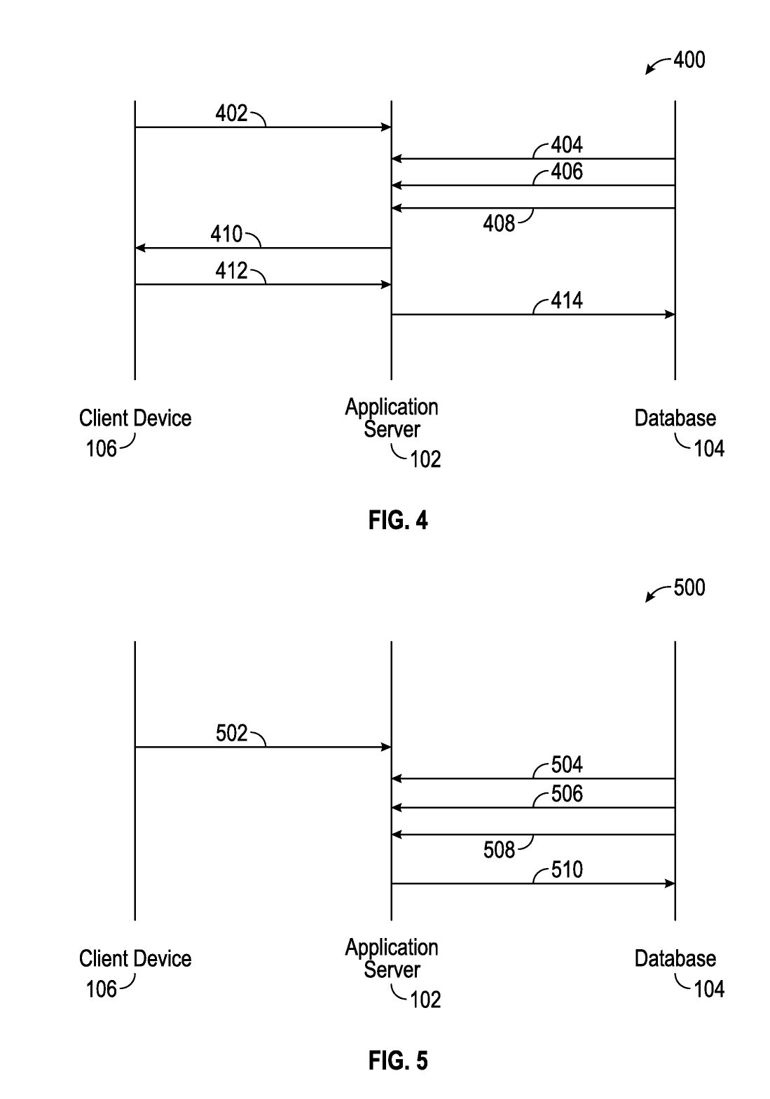

FIG. 4 depicts an exemplary sequence 400 of communications within the on-demand application system 100 in accordance with an exemplary embodiment of the duplicate detection process 300 of FIG. 3. Referring to FIG. 4, and with continued reference to FIGS. 1-3, the illustrated sequence 400 begins with application server 102 receiving 402 an input record for entry to the database 104 from the client device 106. As described above, a user of the client device 106 inputs or otherwise provides values for fields of a new instance of a type of database object that the user would like to create in the database 104 or an existing instance of a database object that the user would like to modify, and the application server 102 creates a corresponding input record (e.g., in memory 111) that maintains the input values received via the client device 106 for the various fields of the instance of the database object type.

In some embodiments, in response to receiving an indication of a desire to submit, save, or otherwise store that instance in the database 104, the application server 102 queries or otherwise accesses 404 the validation table 126 in the database 104 to obtain any validation rules defined by the user's tenant that are applicable to the object type for the input record. After obtaining the applicable validation rule(s), the application server 102 applies the validation rule(s) to the input record to ensure that the input values for the fields of the input record satisfy validation criteria for the respective fields and are valid and acceptable for entry to the database 104. In this regard, if an input value for a field of the input record does not satisfy the applicable validation criteria, the application server 102 may utilize default criteria for that field to set the value of the field to a valid value.

In alternative embodiments, in response to receiving the indication to store an input record to the database 104, the application server 102 may add the input record to a queue or batch of input records for submitting multiple input records to the database 104 at substantially the same time. In such embodiments, the application server 102 may wait to obtain and apply the validation rules from the validation table 126 until the application server 102 determines the batch of input records should be stored. For example, the application server 102 may wait until a threshold number of input records have been queued before storing the batch of input records to the database 104, or the application server 102 may implement a timer or another similar feature to periodically store batches of input records at regular intervals.

Still referring to FIG. 4, after applying validation rules to a respective input record, the application server 102 queries or otherwise accesses 406 the table 124 in the database 104 to obtain the duplicate detection rule associated with the inputting user's tenant that is applicable to the object type for the input record. Thereafter, the application server 102 identifies the tenant's designated uniqueness fields for that object type, obtains the values for those fields of the input record, and calculates an input hash value for the input record by providing the values for those fields of the input record as input parameters to a hash function. After determining the input hash value for the input record, if the input record is being submitted to the database 104 as part of a batch of input records, the application server 102 compares the input hash value to other input hash values for the other input records in the batch to confirm that the input hash value does not match other input hash values. When the input hash value for a respective input record is unique among the other input hash values for the batch of input records, the application server 102 queries or otherwise accesses 408 the destination object table 122 in the database 104 for the input record to obtain existing hash values for the tenant's existing records in that object table 122.

As described above, if the input hash value matches an existing hash value in the destination object table 122 or if the input hash value matches another input hash value among a batch of input records, the application server 102 may initiate one or more remedial actions to avoid potentially entering duplicate input records into the database 104. For example, the application server 102 may provide 410 a notification to the inputting user that the input record is potentially a duplicate of an existing record in the database 104. In exemplary embodiments, the notification includes a GUI element that allows the user to override the duplicate detection, and in response to receiving 412 an indication of a desire to override the duplicate detection from the client device 106, the application server 102 stores, saves, or otherwise enters 414 the input record in the destination object table 122 even though the input hash value associated with the input record is not unique. In the absence of receiving an override indication, the application server 102 discards or otherwise removes the input record (e.g., by deleting the input record from memory 111) and fails to enter the potentially duplicate input record into the database 104.

FIG. 5 depicts another exemplary sequence 500 of communications within the on-demand application system 100 in accordance with an exemplary embodiment of the duplicate detection process 300 of FIG. 3. Referring to FIG. 5, and with continued reference to FIGS. 1-4, the illustrated sequence 500 begins with application server 102 receiving 502 an input record for entry to the database 104, accessing 504 the validation table 126 to obtain and apply validation rules to the input record, and accessing 506 the table 124 to obtain the applicable duplicate detection rule and calculate an input hash value for the input record in a similar manner as described above. If the input record is being submitted to the database 104 as part of a batch of input records, the application server 102 compares the input hash value to other input hash values for the other input records in the batch to confirm that the input hash value does not match other input hash values. When the input hash value for a respective input record is unique among the other input hash values for the batch of input records, the application server 102 accesses 508 the destination object table 122 in the database 104 for the input record to obtain existing hash values for the tenant's existing records in that object table 122. When the input hash value is unique among the existing hash values for the inputting user's tenant, the application server 102 stores, saves, or otherwise enters 510 the input record in the destination object table 122.

FIG. 6 depicts an exemplary embodiment of a multi-tenant system 600 suitable for use as the on-demand application system 100 of FIG. 1. The illustrated multi-tenant system 600 of FIG. 6 includes a server 602 (e.g., application server 102) that dynamically creates and supports virtual applications 628 (e.g., virtual application 116) based upon data 632 from a common database 630 (e.g., database 104) that is shared between multiple tenants, alternatively referred to herein as a multi-tenant database. Data and services generated by the virtual applications 628 are provided via a network 645 (e.g., network 108) to any number of client devices 640 (e.g., client device 106, or the like), as desired. Each virtual application 628 is suitably generated at run-time (or on-demand) using a common application platform 610 (e.g., application platform 112) that securely provides access to the data 632 in the database 630 for each of the various tenants subscribing to the multi-tenant system 600. In accordance with one non-limiting example, the multi-tenant system 600 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 630. In this regard, each tenant includes one or more users associated with, assigned to, or otherwise belonging to that respective tenant. To put it another way, each respective user within the multi-tenant system 600 is associated with, assigned to, or otherwise belongs to a particular tenant of the plurality of tenants supported by the multi-tenant system 600. Tenants may represent customers, customer departments, business or legal organizations, and/or any other entities that maintain data for particular sets of users within the multi-tenant system 600 (i.e., in the multi-tenant database 630). For example, the application server 602 may be associated with one or more tenants supported by the multi-tenant system 600. Although multiple tenants may share access to the server 602 and the database 630, the particular data and services provided from the server 602 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 632 belonging to or otherwise associated with other tenants.

The multi-tenant database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein. In an exemplary embodiment, the database 630 includes a database management system or other equivalent software capable of determining an optimal query plan for retrieving and providing a particular subset of the data 632 to an instance of virtual application 628 in response to a query initiated or otherwise provided by a virtual application 628. The multi-tenant database 630 may alternatively be referred to herein as an on-demand database, in that the multi-tenant database 630 provides (or is available to provide) data at run-time to on-demand virtual applications 628 generated by the application platform 610.

In practice, the data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired. Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

The server 602 is implemented using one or more actual and/or virtual computing systems that collectively provide the dynamic application platform 610 for generating the virtual applications 628. For example, the server 602 may be implemented using a cluster of actual and/or virtual servers operating in conjunction with each other, typically in association with conventional network communications, cluster management, load balancing and other features as appropriate. The server 602 operates with any sort of conventional processing hardware 604, such as a processor 605, memory 606, input/output features 607 and the like. The input/output features 607 generally represent the interface(s) to networks (e.g., to the network 645, or any other local area, wide area or other network), mass storage, display devices, data entry devices and/or the like. The processor 605 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 606 represents any non-transitory short or long term storage or other computer-readable media capable of storing programming instructions for execution on the processor 605, including any sort of random access memory (RAM), read only memory (ROM), flash memory, magnetic or optical mass storage, and/or the like. The computer-executable programming instructions, when read and executed by the server 602 and/or processor 605, cause the server 602 and/or processor 605 to create, generate, or otherwise facilitate the application platform 610 and/or virtual applications 628 and perform one or more additional tasks, operations, functions, and/or processes described herein. It should be noted that the memory 606 represents one suitable implementation of such computer-readable media, and alternatively or additionally, the server 602 could receive and cooperate with external computer-readable media that is realized as a portable or mobile component or application platform, e.g., a portable hard drive, a USB flash drive, an optical disc, or the like.

The application platform 610 is any sort of software application or other data processing engine that generates the virtual applications 628 that provide data and/or services to the client devices 640. In a typical embodiment, the application platform 610 gains access to processing resources, communications interfaces and other features of the processing hardware 604 using any sort of conventional or proprietary operating system 608. The virtual applications 628 are typically generated at run-time in response to input received from the client devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the client devices 640. The virtual applications 628 are typically constructed in accordance with the tenant-specific metadata 638, which describes the particular tables, reports, interfaces and/or other features of the particular application 628. In various embodiments, each virtual application 628 generates dynamic web content that can be served to a browser or other client program 642 associated with its client device 640, as appropriate.

The runtime application generator 620 suitably interacts with the query generator 614 to efficiently obtain multi-tenant data 632 from the database 630 as needed in response to input queries initiated or otherwise provided by users of the client devices 640. In a typical embodiment, the query generator 614 considers the identity of the user requesting a particular function (along with the user's associated tenant), and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user and/or tenant that initiated the request. In this manner, the query generator 614 suitably obtains requested subsets of data 632 accessible to a user and/or tenant from the database 630 as needed to populate the tables, reports or other features of the particular virtual application 628 for that user and/or tenant.

Still referring to FIG. 6, the data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc.

In exemplary embodiments, the application platform 610 is utilized to create and/or generate data-driven virtual applications 628 for the tenants that they support. Such virtual applications 628 may make use of interface features such as custom (or tenant-specific) screens 624, standard (or universal) screens 622 or the like. Any number of custom and/or standard objects 626 may also be available for integration into tenant-developed virtual applications 628. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 626 such as “account” objects, “opportunity” objects, “contact” objects, or the like. The data 632 associated with each virtual application 628 is provided to the database 630, as appropriate, and stored until it is requested or is otherwise needed, along with the metadata 638 that describes the particular features (e.g., reports, tables, functions, objects, fields, formulas, code, etc.) of that particular virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith.

Still referring to FIG. 6, the data and services provided by the server 602 can be retrieved using any sort of personal computer, mobile telephone, tablet or other network-enabled client device 640 on the network 645. In an exemplary embodiment, the client device 640 includes a display device, such as a monitor, screen, or another conventional electronic display capable of graphically presenting data and/or information retrieved from the multi-tenant database 630. Typically, the user operates a conventional browser application or other client program 642 executed by the client device 640 to contact the server 602 via the network 645 using a networking protocol, such as the hypertext transport protocol (HTTP) or the like. The user typically authenticates his or her identity to the server 602 to obtain a session identifier (“SessionlD”) that identifies the user in subsequent communications with the server 602. When the identified user requests access to a virtual application 628, the runtime application generator 620 suitably creates the application at run time based upon the metadata 638, as appropriate. As noted above, the virtual application 628 may contain Java, ActiveX, or other content that can be presented using conventional client software running on the client device 640; other embodiments may simply provide dynamic web or other content that can be presented and viewed by the user, as desired.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to multi-tenancy, cloud computing, on-demand applications, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of managing records in a database, the method comprising:
determining, by a server coupled to the database, a value based on a subset of a plurality of fields of an input record; and
storing the input record in the database when the value is unique among one or more values for one or more existing records in the database, each value of the one or more values being based on the subset of the plurality of fields of a respective existing record of the one or more existing records.

2. The method of claim 1, further comprising:
identifying, by the server, a destination table for the input record, the one or more existing records being maintained in the destination table in the database; and
identifying, by the server, the subset of the plurality of fields indicated by a duplicate detection rule associated with the destination table, wherein the server determines the value based on the subset of the plurality of fields of the input record after identifying the subset of the plurality of fields indicated by the duplicate detection rule associated with the destination table.

3. The method of claim 1, wherein determining the value comprises the server calculating a hash value for the input record based at least in part on one or more input values for one or more fields of the subset.

4. The method of claim 3, wherein:
the one or more values comprise one or more existing hash values, each respective existing hash value of the one or more existing hash values being based on the subset of the plurality of fields of a respective existing record of the one or more existing records;
the one or more existing records are maintained in a destination table of the database; and
storing the input record in the database comprises storing the input record in the destination table when the hash value is unique among the one or more existing hash values.

5. The method of claim 1, further comprising applying, by the server, one or more validation rules to the input record to obtain a validated input record, wherein:
determining the value comprises determining the value based on the subset of the plurality of fields of the validated input record; and
storing the input record in the database comprises storing the validated input record in the database when the value is unique among the one or more values.

6. The method of claim 5, further comprising:
identifying, by the server, a destination table for the input record, the one or more existing records being maintained in the destination table of the database; and
obtaining, by the server, the one or more validation rules associated with the destination table from the database prior to applying the one or more validation rules to the input record, wherein:
determining the value comprises the server calculating a hash value based on the subset of the plurality of fields of the validated input record;
the one or more values comprise one or more existing hash values, each respective existing hash value of the one or more existing hash values being based on the subset of the plurality of fields of a respective existing record of the one or more existing records; and
storing the validated input record comprises the server entering the validated input record in the destination table when the hash value is unique among the one or more existing hash values.

7. The method of claim 6, further comprising identifying, by the server, the subset of the plurality of fields from a duplicate detection rule associated with the destination table prior to calculating the hash value.

8. The method of claim 1, wherein storing the input record comprises storing the input record in the database when the value is unique among values for a batch of input records and among the one or more values for the one or more existing records, each value of the values for the batch of input records being based on the subset of the plurality of fields of a respective input record of the batch.

9. The method of claim 1, further comprising initiating, by the server, a remedial action when the value matches at least one of the one or more values for the one or more existing records.

10. The method of claim 9, wherein initiating the remedial action comprises the server discarding the input record without storing the input record in the database.

11. The method of claim 1, further comprising:
providing, by the server, a virtual application to a client device via a network; and
receiving one or more input values for one or more fields of the subset of the input record via the virtual application, the input record comprising a new instance of an object within the virtual application and the one or more existing records comprising one or more stored instances of the object, wherein determining the value comprises the server determining the value for the input record based at least in part on the one or more input values.

12. A system comprising:
a database to store one or more records; and
a server coupled to the database to determine a value based on a subset of a plurality of fields of an input record and enter the input record in the database when the value is unique among one or more values for the one or more records stored by the database, each value of the one or more values being based on the subset of the plurality of fields of a respective record of the one or more records.

13. The system of claim 12, wherein the server provides a virtual application to a client device over a network and receives one or more input values for one or more fields of the subset of the input record from the client device via the virtual application, the value being determined based at least in part on the one or more input values.

14. The system of claim 13, wherein:
the virtual application comprises a customer relationship management (CRM) application;
the input record comprises a new instance of an object within the CRM application; and
the one or more records comprise one or more stored instances of the object.

15. The system of claim 12, wherein:
the database includes a table having the one or more records stored therein;
the database maintains one or more validation rules associated with the table; and
the server obtains the one or more validation rules associated with the table, applies the one or more validation rules to the input record to obtain a validated input record, and determines the value based on the subset of the plurality of fields of the validated input record.

16. The system of claim 12, wherein:
the database includes a table having the one or more records stored therein;
the database maintains a duplicate detection rule associated with the table, the duplicate detection rule indicating the subset of the plurality of fields; and
the server identifies the subset of the plurality of fields indicated by the duplicate detection rule associated with the table prior to determining the value.

17. The system of claim 12, wherein:
the database includes a table having the one or more records stored therein;
the table maintains an association between each value of the one or more values and the respective record of the one or more records; and
the server enters the input record in the table when the value is unique among the one or more values for the one or more records.

18. A computing system comprising a processing system and a memory, wherein the memory comprises computer-executable instructions that, when executed by the processing system, cause the computing system to:
determine a value based on a subset of a plurality of fields of an input record; and
entering the input record in a database when the value is unique among one or more values for one or more existing records in the database, each value of the one or more values being based on the subset of the plurality of fields of a respective existing record of the one or more existing records.

19. The computing system of claim 18, wherein the computer-executable instructions cause the computing system to:
provide a virtual application to a client device via a network; and
receive one or more input values for one or more fields of the subset of the input record via the virtual application, the input record comprising a new instance of an object within the virtual application and the one or more existing records comprising one or more stored instances of the object, wherein determining the value comprises determining the value for the input record based at least in part on the one or more input values.

20. The computing system of claim 19, wherein the computer-executable instructions cause the computing system to determine the value for the input record by calculating a hash value based on the subset of the plurality of fields of the input record, the one or more values comprising one or more hash values based on the subset of the plurality of fields of the one or more existing records.
